(19) United States
(12) Patent Application Publication
(10) Pub. No.: US 2025/0344671 A1
(43) Pub. Date: Nov. 13, 2025

(54) PET GROOMING DEVICE

(71) Applicant: Furs N' Purs LLC, Eatontown, NJ (US)

(72) Inventor: Hillel Ort, Eatontown, NJ (US)

(21) Appl. No.: 18/661,318

(22) Filed: May 10, 2024

(51) Int. Cl. A01K 13/00

(52) U.S. Cl. CPC A01K 13/002

(57) ABSTRACT

A pet groomer that has an air flow generator section. The air flow generator section includes a housing, a vacuum generator inside the housing, a blower inside the housing, a first air flow port in fluid communication with the vacuum generator, and a second air flow port in fluid communication with the blower. The pet groomer includes an air flow hose having a first end detachably attachable to the first air flow port, and the second flow port, and at least one attachment detachably attachable to a second end of the air flow hose.

### BACKGROUND OF THE INVENTION

The present invention relates to a pet grooming device with an air suction functionality and air blow functionality.

### BACKGROUND

Pet grooming devices with a vacuum function are known. See, for example, U.S. 2002/0189049, and U.S. Pat. No. 5,115,765.

Pet grooming devices with a blower function are known. See, for example, U.S. Pat. No. 5,279,256.

### SUMMARY OF THE INVENTION

It is an object of the present invention to provide a pet groomer that has a vacuum feature and a blower feature.

A pet groomer according to the present invention includes an air flow generator section that includes a housing, a vacuum generator inside the housing, a blower inside the housing, a first air flow port in fluid communication with the vacuum generator, and a second air flow port in fluid communication with the blower; an air flow hose having a first end detachably attachable to the first air flow port, and the second flow port; and at least one attachment detachably attachable to a second end of the air flow hose.

The first air flow port and the second air flow port may be located at opposite ends of the housing of the air flow generator section.

The at least one attachment may be a brush attachment comprising a brush.

The at least one attachment may be a clipper attachment comprising a clipper.

The air flow generator section may further includes a heater located between the blower and the second air flow port.

A control panel may be provided allow the user to control the vacuum generator and the blower, the control panel having a manual ON/OFF button, a manual vacuum generator selection button, a manual blower selection button, and a manual heater control button.

A collection chamber may be provided in the housing between the first air flow port and the vacuum generator. A disposable or a non-disposable filter may be located in the collection chamber.

The vacuum generator may include a vacuum pump.

The blower may include a motorized fan.

Other features and advantages of the present invention will become apparent from the following description of the invention which refers to the accompanying drawings.

### BRIEF DESCRIPTION OF THE DRAWINGS

FIG. 1 shows a bottom view of a device according to the present invention.

FIG. 2 shows a top view of the device shown in FIG. 1.

FIG. 3 shows a control panel for the device shown in FIG. 2.

FIG. 4 schematically shows the components of the air flow generator section of the device of FIG. 1.

FIG. 5 shows a few attachments that are detachably attachable to the device of FIG. 1.

### DETAILED DESCRIPTION OF EMBODIMENTS OF THE INVENTION

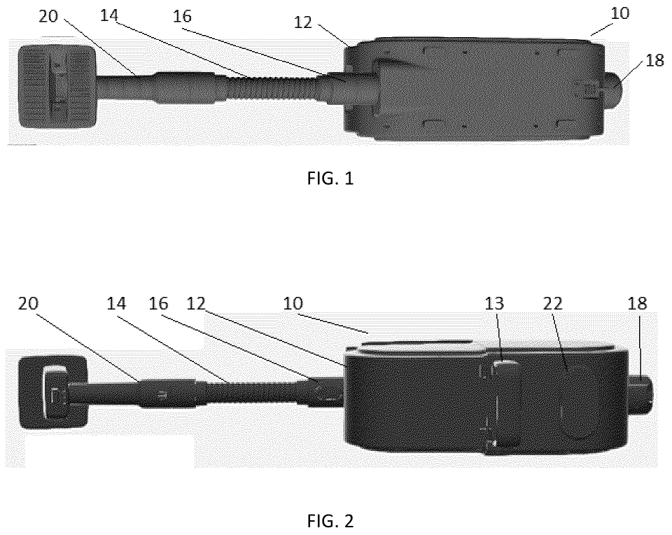

Referring to FIGS. 1 and 2, a device 10 according to the present invention includes an air flow generator section 12, and an air flow hose 14.

The air flow hose 14 is detachably attachable to air flow ports 16, 18 at a first end thereof, and detachably attachable to an attachment 20 at an opposite, second end thereof.

When attached, the air flow hose 14 is in fluid communication with the air flow port 16 or air flow port 18.

When attached, the attachment 20 is in fluid communication with the air flow hose 14.

The air flow generator section 12 may also include a handle 13 for transportation.

One of the air flow ports 16 is an air input to serve as a vacuum port for and in fluid communication with (i.e. permitting the passage of fluids such as gas to) a vacuum generator (32, FIG. 4) located inside the housing (34, FIG. 4) of the air flow generator section 12 of the device 10 and the other of the two air flow ports 18 is an air output port to serve as a blower port for and in fluid communication with (i.e. permitting the passage of fluids such as gas to) a blower (36, FIG. 4) located inside the housing (34, FIG. 4) of the air flow generator section 12 of the device 10.

The air flow hose 14 provides a fluid channel that permits passage of air from the attachment 20 into the flow generator section 12 via the air flow port 16 or from the air flow port 18 to the attachment 20.

The attachment 20 can serve as either an air input component, an air output component, or both. Thus, the attachment will have a body having a channel through which air may be passed to the air flow hose 14.

The detachable attachment of the air flow hose to the air flow ports 16, 18 and the detachable attachment of the air flow hose 14 to the attachment 20 may be air-tight to ensure efficient air suction into the air flow generator section 20 (when the air flow hose 14 is attached to the air flow port 16), and efficient ejection of air via the air flow hose 14 and the attachment 20 (when the air flow hose 14 is attached to the air flow port 18).

The air-tight attachment of the air flow hose 14 to the ports 16, 18 may be realized by making the first end of the air flow hose 14 slightly wider than the air flow ports 16, 18 so that the air flow ports 16, 18 may be received inside the first end of the air flow hose 14 to make intimate and snug contact with the interior surface of the first end the air flow hose 14.

Alternatively, the air-tight attachment of the air flow hose 14 to the ports 16, 18 may be realized by making the first end of the air flow hose 14 slightly narrower than the air flow ports 16, 18 so that the first end of the air flow hose 14 may be received in the air flow ports 16, 18 to make intimate and snug contact with the interior surfaces of the air flow ports 16, 18.

The air-tight attachment of the air flow hose 14 to the attachment 20 may be realized by making the second end of the air flow hose 14 slightly wider than the input end of the attachment 20 so that input end of the attachment 20 may be received inside the second end of the air flow hose 14 to make intimate and snug contact with the interior surface of the second end the air flow hose 14.

Alternatively, the air-tight attachment of the air flow hose 14 to the attachment 20 may be realized by making the second end of the air flow hose 14 slightly narrower than the input end of the attachment 20 so that the input end of the attachment 20 may receive therein the second end of the air flow hose 14 to make intimate and snug contact with the exterior surface of the second end the air flow hose 14.

The air flow hose 14 may be a bellows flexible vacuum hose or any other suitable flexible hose.

The vacuum generator 32 may be a vacuum pump.

The blower 36 may comprise a motor operated fan.

It should be noted that the vacuum generator 32 and the blower 36 may be realized in one device.

A device 10 according to the present invention further includes suitable circuitry residing in the housing 34 to operate the vacuum generator 32 and the blower 36, including a power supply 35 that can be controlled to change the output of the vacuum generator 32 and the blower 36.

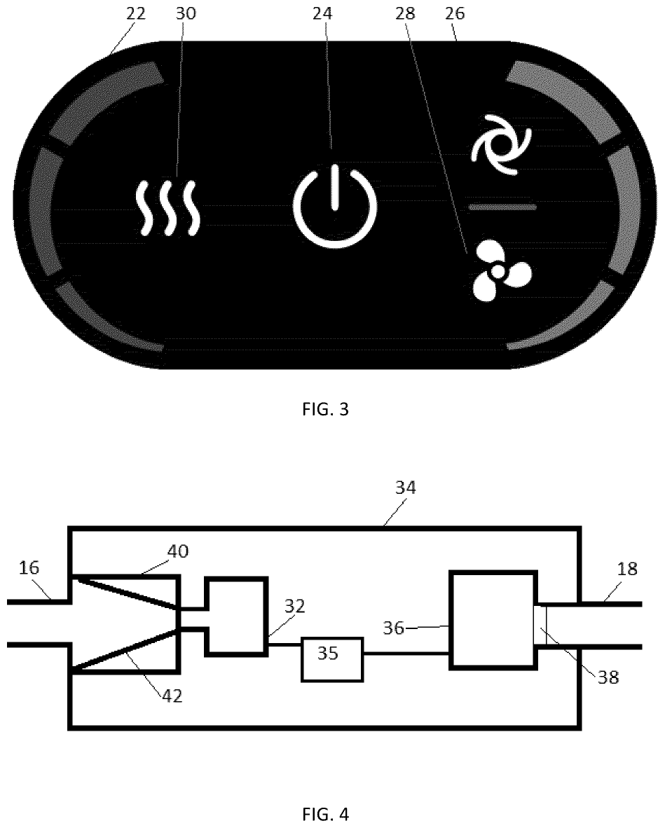

Referring to FIGS. 2 and 3, the air flow generator 12 includes a control panel 22. The control panel 22 is operably connected to the circuitry that controls the vacuum generator 32 and the circuitry that controls the blower 36.

The control panel 22 has a manual OFF/ON button 24 for turning the device 10 ON and/or OFF, a manual vacuum selection button 26 to turn the vacuum generator 32 on and/or off, a manual blower button 28 to turn the blower 36 on and/or off, and a temperature selection button 30 to change the temperature of the air that is blown from the air flow port 18.

To increase the temperature of the air exiting the air flow port 18 a heater (38, FIG. 4) may be provided inside of the housing (34, FIG. 4) of the air flow generator section 12 of the device 10 preferably in the path of the air that is ejected from the air flow port 18. The temperature selection button 30 permits the user to control the heat output of the heater 38.

The heater 38 includes a heating element and suitable circuitry operably connected to the control panel 22 to permit the control of the output of the heating element.

Referring to FIG. 4, the device 10 further includes a collection chamber 40 located inside of the housing 34 of the air flow generator 12. The collection chamber 40 is located between the air flow port 16 and the vacuum generator 32 such that air passes from the port 16 toward the vacuum generator 32 when the vacuum generator 32 is operating. A removable filter 42 may be provided in the path of the air flowing from the port 16 to the vacuum generator 32 to intercept and collect whatever (for example, pet hair) that is being pulled toward the vacuum generator 32. The removable filter 42 may be made of a disposable material (e.g. a paper-based material) or may be a re-usable filter made of a durable material (e.g. a metallic mesh) which can be removed, cleaned, and put back into its place inside of the collection chamber 40.

The device 10 may be battery-operated in which case a battery pack of rechargeable batteries may provide power to the vacuum generator, the blower, and the heater.

The device 10 may receive power via a power cord from a power outlet to provide power to the vacuum generator, the blower, and the heater.

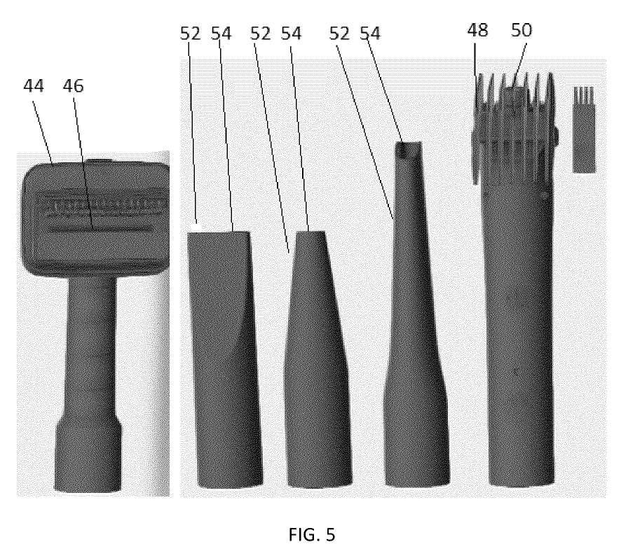

FIG. 5 shows a number of attachments that could be detachably attached to the second end of the air flow hose 14 in an air-tight manner as previously described.

One attachment 20 may be a brush attachment 44 that includes a brush. The brush attachment 44 has a port 46, which leads to a channel connected to the input end of the brush attachment. When the brush attachment 44 is attached to the air flow hose 14 while the air flow hose 14 is connected to the air flow port 16 and the vacuum generator 32 is operating, the pet hair collected by the brush may be sucked into the collection chamber 40 and collected in the filter 42.

Another attachment 20 may be a clipper attachment 48 that includes a clipper. The clipper attachment 48 also has a port 50, which leads to a channel connected to the input end of the clipper attachment 48. When the clipper attachment 48 is attached to the air flow hose 14 while the air flow hose 14 is connected to the air flow port 16 and the vacuum generator 32 is operating, the pet hair that is clipped by the clipper may be sucked into the collection chamber 40 and collected in the filter 42.

An attachment 20 may be selected from other attachments 52. The other attachments 52 have ports 54 of different sizes and shapes to vary the speed and/or pattern of the passing air. Each port 54 leads into a channel connected to the input end of the attachment 52. The other attachments 52 may be detachably connected in an air-tight manner as described to the air flow hose 14 when the air flow hose 14 is connected to the air flow port 16 to serve as vacuum attachments or when the air flow hose 14 is connected to air flow port 18 to serve as blower attachments.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A pet groomer, comprising:
an air flow generator section that includes a housing, a vacuum generator inside the housing, a blower inside the housing, a first air flow port in fluid communication with the vacuum generator, and a second air flow port in fluid communication with the blower;
an air flow hose having a first end detachably attachable to the first air flow port, and the second flow port; and
at least one attachment detachably attachable to a second end of the air flow hose.

2. The pet groomer of claim 1, wherein the at least one attachment is a brush attachment comprising a brush.

3. The pet groomer of claim 1, wherein the at least one attachment is a clipper attachment comprising a clipper.

4. The pet groomer of claim 1, wherein the air flow generator section further comprises a heater located between the blower and the second air flow port.

5. The pet groomer of claim 4, further comprising a control panel to control the vacuum generator and the blower, the control panel having a manual ON/OFF button, a manual vacuum generator selection button, a manual blower selection button, and a manual heater control button.

6. The pet groomer of claim 1, further comprising a collection chamber located between the first air flow port and the vacuum generator.

7. The pet groomer of claim 6, further comprising a filter located in the collection chamber.

8. The pet groomer of claim 1, wherein the vacuum generator comprises a vacuum pump.

9. The pet groomer of claim 1, wherein the blower comprises a fan.

10. The pet groomer of claim 1, further comprising a control panel to control the vacuum generator and the blower, the control panel having a manual ON/OFF button, a manual vacuum generator selection button, and a manual blower selection button.

11. The pet groomer of claim 1, wherein the first air flow port and the second air flow port are located at opposite ends of the housing of the air flow generator section.
